(19) United States
(12) Patent Application Publication
(10) Pub. No.: US 2016/0267588 A1
(43) Pub. Date: Sep. 15, 2016

(54) SYSTEMS AND METHODS OF FINANCING PREAPPROVAL AND PREQUALIFICATION OPTIONS FOR EQUITY MINING

(71) Applicant: Experian Information Solutions, Inc., Costa Mesa, CA (US)

(72) Inventors: Ryan B. Cain, Elgin, IL (US); Will Hope, Sugar Grove, IL (US); Kirsten Marie Von Busch, Palatine, IL (US); Dominic Edward DeGuiseppe, Naperville, IL (US)

(21) Appl. No.: 15/069,807

(22) Filed: Mar. 14, 2016

Related U.S. Application Data
(60) Provisional application No. 62/132,703, filed on Mar. 13, 2015.

(51) Int. Cl. G06Q 40/02

(52) U.S. Cl. CPC G06Q 40/025

(57) ABSTRACT

One embodiment of the system described herein provides an interface for operation at a remote computing device and receive a list of consumers and vehicles for prequalification and equity determinations. The system further receives one or more criteria, obtains credit history records for at least one consumer on the first list, and compares at least obtained credit history record with the received one or more criteria. The system further identifies which consumers of the first list exceed the one or more criteria, obtains vehicle history records for at least one vehicle on the first list, and calculates vehicle equity values for the at least one vehicle on the first list. The system further generates generate a second list of consumers that are prequalified and vehicle equity values for conveyance via the interface.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57. This application claims the benefit of U.S. Provisional Application 62/132,703, filed Mar. 13, 2015, and entitled “STREAMLINED FINANCING PREAPPROVAL AND PREQUALIFICATION OPTIONS FOR VEHICLE EXCHANGES, and assigned to the assignee hereof, the disclosure of which is considered part of this application, and is hereby incorporated by reference in its entirety for all purposes.

### BACKGROUND

This application relates to providing information regarding consumer prequalification and existing equity in consumer vehicles to the consumer and other interested parties. Specifically, this application relates to providing a vehicle dealer (or vehicle service provider) with the prequalification and vehicle equity determinations of consumers for use in generating credit offers to the consumers. The consumers may be identified based on expected visitation dates to the dealer, for example for scheduled service visits, or based on consumer opt ins while browsing the dealer's website or other vehicle listing websites.

The decision to buy or lease a specific vehicle involves a consumer's ability to finance a purchase or lease of the specific vehicle. Systems available today only provide an ability to determine financing options available to consumers for a vehicle, independent of the existing equity the consumer may have in a different vehicle in their possession.

Owners and/or lessees often schedule servicing of their vehicle with dealers in advance of the actual date of servicing. Accordingly, the dealers often have a listing of vehicles and owners/lessees that will be visiting their facilities on a given day. The dealers may wish to use the service visits by the owners/lessees as opportunities to advise the owners/lessees regarding their options to replace their existing vehicles or purchase an additional vehicle. However, in order to more effectively and efficiently use the dealer's and the owner/lessee's time, the dealer may wish to identify those owners/lessees who are in a financial position to replace their vehicle or purchase a new vehicle. For example, an owner/lessee may want to replace their vehicle every two years, and the owner's current vehicle is nearing that two year life span. Alternatively, or additionally, the owner/lessee may have recently paid off a current vehicle, or the owner/lessee is currently paying off a current vehicle and has reached a certain threshold. These are examples of situations of which dealers may want notice. Accordingly, systems and methods of identifying owners/lessees at specific stages in their financial relationships with their vehicles or at particular stages in their ownership/lease are desired.

### SUMMARY

Various implementations of methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the subject matter described herein comprises a consumer prequalification and vehicle equity determination system. The system comprises a communication circuit configured to communicate via a communication network, a memory, and a processor. The processor is configured to provide an interface for operation at a remote computing device over the communication network and receive, via the interface, a first list of one or more consumers, the first list comprising at least a first name of and a last name of at least one consumer on the list and at least one vehicle owned by the at least one consumer on the list, the at least one vehicle on the first list identified by at least one of a vehicle identification number (VIN), license plate number, or other unique identifier. The processor is also configured to receive one or more criteria for determining a prequalification status of the at least one consumer on the first list and identify which consumers of the first list have credit history records that satisfy the one or more criteria. The processor is further configured to calculate vehicle equity values for the at least one vehicle on the first list based on vehicle history records and the credit history record of a corresponding owning consumer on the first list. The processor is also further configured to generate a second list of consumers based on comparison of credit history records and received one or more criteria and vehicles based on the calculated vehicle equity values and convey the second list via the interface.

In another aspect, the one or more criteria is received via the interface and wherein the one or more criteria are selected based on lender or underwriter requirements, guidelines, or scoring models. In another aspect, the processor is further configured to obtain vehicle history records for the at least one vehicle on the first list corresponding to consumers identified as having credit history records satisfying the one or more criteria.

In another aspect, the processor is further configured to generate the second list comprising only those consumers identified as having credit history records satisfying the one or more criteria and vehicles associated with those consumers. In one aspect, the received one or more criteria comprises a plurality of tiers, wherein at least one tier of the plurality of tiers includes different criteria and wherein identification of which consumers of the first list have credit history records that satisfy the one or more criteria comprises identifying which tier of the plurality of tiers for which at least one consumer of the first list qualifies.

In an aspect, the processor is further configured to generate the second list to further contain indications of which tier at least one consumer of the second list qualifies. In one aspect, the second list is used to facilitate vehicle sales or loans and wherein the processor is further configured to cause a display of vehicles for sale to be limited based on at least one of the at least one consumer's tier indications, credit history record satisfying the one or more criteria, or the at least one vehicle's equity value. In another aspect, the processor is configured to identify which consumers of the first list have credit history records that satisfy the one or more criteria comprises configuring the processor to obtain credit history records for the at least one consumer on the first list and compare the obtained credit history record with the received one or more criteria.

Another aspect of the subject matter described herein comprises an. apparatus for determining a consumer prequalification and a vehicle equity. The apparatus comprises means for communicating via a communication network, means for storing data, and means for providing an interface for operation at a remote computing device over the communication network. The apparatus further comprises means for receiving a first list of one or more consumers, the first list comprising at least a first name of and a last name of at least one consumer on the first list and at least one vehicle owned by the at least one consumer on the first list, the at least one vehicle on the first list identified by at least one of a vehicle identification number (VIN), a license plate number, or other unique identifier and means for receiving one or more criteria for determining a prequalification status of the at least one consumer on the first list. The apparatus also means for identifying which consumers of the first list have credit history records that satisfy the one or more criteria and means for calculating vehicle equity values for the at least one vehicle on the first list based on the corresponding obtained vehicle history records and the credit history record of a corresponding owning consumer on the first list. The method also further comprises means for generating a second list of consumers based on comparison of credit history records and received one or more criteria and vehicles based on the calculated vehicle equity values and means for conveying the second list via the interface.

In another aspect, the one or more criteria is received via the interface and wherein the one or more criteria are selected based on lender or underwriter requirements, guideline, or scoring models. Another aspect further comprises means for obtaining vehicle history records for the at least one vehicle on the first list corresponding to consumers identified as having credit history records satisfying the one or more criteria.

In one aspect, the means for generating the second list is configured to generate the second list to comprise only those consumers identified as having credit history records satisfying the one or more criteria and vehicles associated with those consumers. In another aspect, the received one or more criteria comprises a plurality of tiers, wherein at least one tier of the plurality of tiers includes different criteria and wherein the means for identifying which consumers of the first list have credit history records that satisfy the selected one or more criteria is configured to identify which tier of the plurality of tiers for which the at least one consumer of the first list qualifies.

In one aspect, the means for generating the second list comprises indicating, in the second list, the tier for which at least one consumer of the second list qualifies. In one aspect, the second list is used to facilitate vehicle sales or loans, the apparatus further comprising means for causing a display of vehicles for sale to be limited based on at least one of the at least one consumer's tier indications, credit history record satisfying the one or more criteria, or the at least one vehicle's equity value.

In one aspect, the means for identifying which consumers of the first list have credit history records that satisfy the one or more criteria comprises means for obtaining credit history records for the at least one consumer on the first list and means for comparing at least one obtained credit history record with the received one or more criteria.

Another aspect of the subject matter described herein comprises a method for determining a consumer prequalification and a vehicle equity. The method comprises receiving, via an interface, a first list of one or more consumers, the first list comprising at least a first name of and a last name of at least one consumer on the list and at least one vehicle owned by the at least one consumer on the list, the at least one vehicle on the first list identified by at least one or more of a vehicle identification number (VIN), a license plate number, or other unique identifier and receiving one or more criteria for determining a prequalification status of the at least one consumer on the first list. The method further comprises identifying which consumers of the first list have credit history records that satisfy the one or more criteria and calculating vehicle equity values for the at least one vehicle on the first list based on obtained vehicle history records and the credit history record of a corresponding owning consumer on the first list. The method also comprises generating a second list of consumers based on comparison of credit history records and the received one or more criteria and vehicles based on the calculated vehicle equity values and conveying the second list via the interface.

In one aspect, the one or more criteria is received via the interface and wherein the one or more criteria are selected based on lender or underwriter requirements, guideline, or scoring models. Another aspect further comprises obtaining vehicle history records for the at least one vehicle corresponding to consumers identified as having credit history records satisfying the one or more criteria. In another aspect, generating the second list comprises generating the second list to only comprise those consumers identified as having credit history records satisfying the one or more criteria and vehicles associated with those consumers.

In one aspect, the received one or more criteria comprises a plurality of tiers, wherein at least one tier of the plurality of tiers includes different criteria and wherein identifying which consumers of the first list have credit history records that satisfy the selected one or more criteria comprises identifying which tier of the plurality of tiers for which the at least one consumer of the first list qualifies. In another aspect, generating the second list comprises indicating, in the second list, the tier for which at least one consumer of the second list qualifies. In one aspect, the second list is used to facilitate vehicle sales or loans, the method further comprising causing a display of vehicles for sale to be limited based on at least one of the at least one consumer's tier indications, credit history record satisfying the one or more criteria, or the at least one vehicle's equity value.

In another aspect, identifying which consumers of the first list have credit history records that satisfy the one or more criteria comprises obtaining credit history records for the at least one consumer on the first list and comparing at least one obtained credit history record with the received one or more criteria.

An additional aspect of the subject matter described herein comprises a computer program product comprising a computer readable medium including instructions that, when executed, cause an apparatus to perform a method. The method comprises receiving, via an interface, a first list of one or more consumers, the first list comprising at least a first name of and a last name of at least one consumer on the list and at least one vehicle owned by the at least one consumer on the list, the at least one vehicle on the first list identified by at least one or more of a vehicle identification number (VIN), a license plate number, or other unique identifier and receiving one or more criteria for determining a prequalification status of the at least one consumer on the first list. The method also comprises identifying which consumers of the first list have credit history records that satisfy the one or more criteria and calculating vehicle equity values for the at least one vehicle on the first list based on obtained vehicle history records and the credit history record of a corresponding owning consumer on the first list. The method further comprises generating a second list of consumers based on comparison of credit history records and the received one or more criteria and vehicles based on the calculated vehicle equity values and conveying the second list via the interface.

### BRIEF DESCRIPTION OF THE DRAWINGS

The above-mentioned aspects, as well as other features, aspects, and advantages of the present technology will now be described in connection with various aspects, with reference to the accompanying drawings. The illustrated aspects, however, are merely examples and are not intended to be limiting. Throughout the drawings, similar symbols typically identify similar components, unless context dictates otherwise. Note that the relative dimensions of the following figures may not be drawn to scale.

FIG. 1 illustrates one possible organization of a communication system for streamlined financing preapproval and prequalification options and vehicle equity determinations (e.g., a vehicle equity/finance system).

FIG. 2 is a block diagram corresponding to hardware and/or software components of an example embodiment of the vehicle equity/finance system of FIG. 1.

FIG. 3 is a process flowchart illustrating an example method of generating a prequalification determination and vehicle equity determination based on the consumer request.

FIG. 4 is a process flowchart illustrating an example method of generating a prequalification determination and an equity determination for credit offers by a dealer or lender.

FIG. 5 depicts a processor flow diagram for an example method of generating and providing prequalification and equity information.

FIG. 6 depicts a process flow diagram for another method of generating and providing prequalification and equity information.

FIG. 7 shows a process flow diagram of an example method of performing prequalification and equity determinations based on received information and returning results to a requesting entity.

### DETAILED DESCRIPTION

Various aspects of the novel systems, apparatuses, and methods are described more fully hereinafter with reference to the accompanying drawings. The teachings disclosed may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different consumer goods and services industries. The detailed description and drawings are merely illustrative of the disclosure rather than limiting, the scope of the disclosure being defined by the appended claims and equivalents thereof.

Popular network technologies may include various types of wireless or wired networks. The wireless or wired network may be used to interconnect nearby devices together, employing widely used networking protocols. The various aspects described herein may apply to any communication standard, such as a wireless 802.11 protocol.

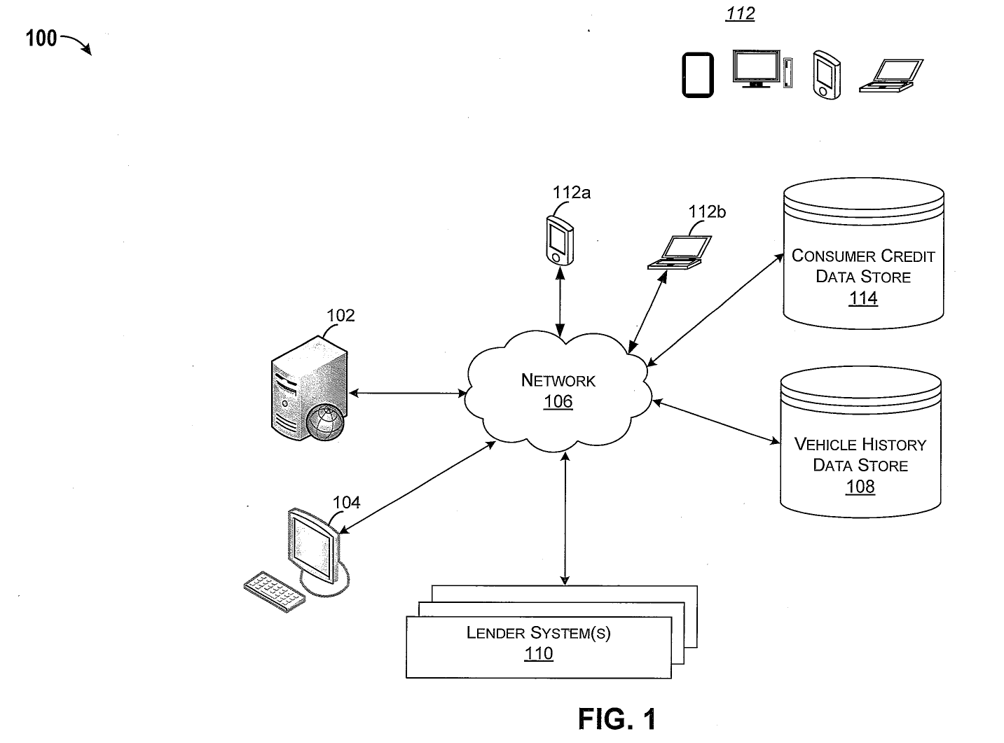

FIG. 1 illustrates one possible organization of a communication system 100 for streamlined financing preapproval and prequalification options and vehicle equity determinations (e.g., a vehicle equity/finance system 102). The system 100 comprises a network 106, a dealer terminal 104, the vehicle equity/financing system (VEFS) 102, a vehicle history data store 108, one or more lender systems 110, one or more computing devices 112, and a consumer credit data store 114. Additionally, communication links are shown enabling communication among the components of the communication system 100 via the network 106. In some embodiments, one or more of the servers and terminals described herein may be combined into a single server and/or terminal combination device. In some embodiments, two or more of the components described above may be integrated. In some embodiments, one or more of the components may be excluded from the system 100. The communication system 100 may be used to implement systems and methods described herein.

In some embodiments, a consumer may use one of the computing terminals 112a or 112b to communicate with a dealer and/or a service provider (e.g., via the network 106 to the dealer terminal 104) to schedule an appointment to have an owned or leased vehicle serviced. For example, the consumer may use the computing terminal 112a to call the dealer directly and/or to access a dealer website. In some embodiments, when communicating with the dealer, the consumer may be prompted for information not relating directly to the scheduled service. For example, the consumer may be prompted to sign-in to an account with the dealer. In some embodiments, the consumer may be prompted to provide personal information (e.g., full name, contact information, and address) to the dealer with a request to opt-in for additional services (e.g., opt-in to receive various credit offers, etc.).

In some embodiments, the consumer may have the account with the dealer, by which the dealer stores information regarding the vehicle(s) and/or the consumer. In some embodiments, the vehicle information may include vehicle identification numbers (VINs) for each vehicle associated with the consumer, service records for each vehicle, purchase dates, mileage, model type, model year, options packages, loan status, etc. In some embodiments, the consumer information may include the consumer's personal information (e.g., name, address, contact information, financial information, credit information, previous receipts or payment issues, etc.). In some embodiments, the vehicle and consumer information may be obtained directly from the consumer and/or vehicle and from previous transactions with the consumer and/or vehicle. In some embodiments, the vehicle and/or consumer information may be obtained from one or more publicly accessible data sources, assuming the consumer agreed to provide the information to the dealer for their records, such as the consumer credit data store 114 and the vehicle history data store 108.

In some embodiments, the computing terminal 112 may comprise a laptop, a desktop, a tablet, a mobile phone, a PDA, or any other mobile or stationary computing device with which the consumer may browse the Internet or make calls. In some embodiments, the consumer may be scheduling an appointment with a service provider for another good besides a vehicle for which purchase records are tracked, for example a home, a marine vehicle, or similar goods which may involve financing and have ownership history that is tracked. For simplicity, as described herein, the consumer will have the vehicle serviced by the dealer.

When scheduling the appointment for service, the consumer may select one or more days on which the consumer is available to bring their vehicle to the dealer for servicing. Details regarding the appointment, as well as information of the vehicle to be serviced and/or consumer information of the consumer may be stored by the dealer, for example in the dealer terminal 104 via the network 106. In some embodiments, the dealer may also prompt the consumer for additional information for purposes of a credit offer and/or current equity determinations. For example, the dealer may request that the consumer provide, via the computing terminal 112a, credit information or personal information allowing the dealer to acquire the consumer's credit information (e.g., social security number, “SSN”), and vehicle and/or personal information allowing the dealer to identify the equity the consumer has established in the one or more vehicles that the consumer owns (or leases). Alternatively, or additionally, when accessing the dealer's website, the consumer may employ a widget, popup window, or other similar browsing component to provide information as described herein. In some aspects, the consumer may be prompted to provide consent to or opt-in to receiving the credit or other offers.

The VEFS 102 may comprise a server or system that provides one or more of financing prequalification determinations and vehicle equity determinations. In some embodiments, the VEFS 102 may be split into two or more separate servers or systems, for example, one dedicated to the prequalification determinations and one for the equity determinations. For example, the VEFS 102 may be able to provide the prequalification determination for a consumer whose information is provided to the VEFS 102 and may be able to determine equity established in a vehicle given information regarding the vehicle (e.g., vehicle identification number (VIN) or other unique identifying information, such as a license plate, etc.) and the consumer who owns/leases the vehicle. In some embodiments, the vehicle and consumer information may be provided by a dealer looking to find potential consumers interested in and able to purchase a new or used vehicle. Additionally, or alternatively, the VEFS 102 may provide the prequalification determinations and equity determinations to consumers directly based on general credit criteria or specific dealer or lender criteria without involving the dealer or lender directly. Accordingly, the consumer may identify its options without dealer or lender involvement or pressures.

In providing the prequalification determinations and the equity determinations, the VEFS 102 may retrieve the vehicle history information from the vehicle history data store 108 and/or the consumer (via computing devices 112) and/or the dealer (via the dealer terminal 104). The vehicle history data store 108 may comprise a database or other storage device containing vehicle history information organized in a searchable manner. In some embodiments, the vehicle history data store 108 may comprise a plurality of databases or sources, including third party databases or sources, such as an industry publication database, a safety ratings database, and a vehicle specification database, that include information regarding a vehicle history. In some embodiments, the vehicle history data store 108 may comprise searchable data stored as vehicle history reports. The vehicle history information may aggregate information about a specific vehicle. In some embodiments, the vehicle history information may include information regarding accident history, mileage history, ownership history, purchase records, registration records, among others, for a designated vehicle (identified by the VIN or unique identifying information).

Similarly, in providing the prequalification determinations and the equity determinations, the VEFS 102 may retrieve the consumer information from the consumer credit data store 114 and/or the consumer (via computing devices 112) and/or the dealer (via the dealer terminal 104). The consumer credit data store 114 may comprise a database or other storage device comprising consumer credit information organized in a searchable manner. In some embodiments, the consumer credit data store 114 may comprise a plurality of databases or sources, including third party databases or sources, such as industry credit bureaus that include information regarding consumer credit. In some embodiments, the consumer credit data store 114 may comprise searchable data stored as credit reports. The consumer credit data store 114 may aggregate information about a specific consumer. In some embodiments, the consumer credit information may include information regarding purchase and payment history, employment history, ownership interests, outstanding debts, account balances, among others, for a designated consumer (identified by a social security number, name and address, or unique identifying information).

Accordingly, in some embodiments, the VEFS 102 (or similar device) may request and extract appropriate data for the vehicle to be serviced and/or the consumer that owns the vehicle according to the scheduled service request. In some embodiments, the extracted vehicle and consumer data or information may be provided to the requesting party (e.g., the dealer or the consumer). Additionally, or alternatively, the extracted data or the information, or portions thereof, may be used in the prequalification determination and/or the vehicle equity determination. The VEFS 102 can thus be configured to request and receive data from various databases and provide the desired determinations.

The VEFS 102 may determine the prequalifications for the consumer based on potential financing offers from one or more financing institutions and/or dealers. For example, when the prequalification determination is requested by a dealer, the VEFS 102 may determine the prequalifications for the consumer based on dealer backed financing offers. In some embodiments, when the prequalification determination is requested by a dealer, the VEFS 102 may determine prequalifications for the consumer based on lender backed financing offers if the dealer so indicates. In some embodiments, the dealer/lender may select one or more financing offers and options with regard to the prequalification determination for the consumer.

Accordingly, the VEFS 102 may utilize the consumer information received from the dealer, the consumer, and/or the consumer credit data store 114 to determine the consumer's prequalifications in view of qualification criteria for the selected or available financing offers. In determining the prequalification for potential financing offers, the VEFS 102 may retrieve the qualification criteria directly from financing institutions (e.g., lenders systems 110 or dealer terminal 104). The VEFS 102 may determine whether the consumer is prequalified by comparing the received consumer information with the qualification criteria. If the consumer meets the qualification criteria, then the consumer may be approved or “pass.” If the consumer does not meet the qualification criteria, then the consumer may not be approved or “not pass.” In some embodiments, lender systems 110 may be part of the system 100 and may be configured to provide financing offers to the VEFS 102 for prequalification determinations. In some embodiments, the criteria may be selected by the dealer based on the lender backing the loans. In some embodiments, the lender itself may select the criteria. In some embodiments, the criteria may be selected based on underwriter guidelines or requirements or custom scoring models.

Results from the prequalification determination may be provided to the requesting party via the network 106 for display on the appropriate device (e.g., dealer terminal 104 or computing device 112). In some embodiments, a prequalification determination for the consumer may prompt an immediate alarm that is communicated to the requesting party. In some embodiments, the alarm may be communicated to any parties that may be interested in the determination (e.g., dealers and lenders). In some embodiments, this alarm may be communicated via the network 106 or via another communication method as identified by the consumer information received by the VEFS 102.

Similarly, the VEFS 102 may utilize the consumer information received from the dealer, the consumer, and/or the consumer credit data store 114 and the vehicle history received from the dealer, the consumer, and/or the vehicle history data store 108 to determine the vehicle's equity. In determining equity, the VEFS 102 may retrieve the original purchase information directly from a dealer or the consumer (e.g., dealer terminal 104 or computing device 112). The VEFS 102 may determine an amount of equity in the vehicle by identifying the purchase/loan/lease date from the vehicle history information and identifying consumer payment history on that purchase/loan/lease from information received from the consumer and/or the consumer credit data store 114. For example, when the purchase/loan/lease origination date can be identified and the consumer's payment history on that purchase/loan/lease can be verified, the VEFS 102 may determine an amount of equity in the vehicle based on details of the loan (e.g., original balance, payment terms, loan/lease terms, etc.).

In some embodiments, the equity information may be used as a factor in consumer prequalification. In some embodiments, the equity information may be passed to the requesting party via the network 106 for display on the appropriate device (e.g., dealer terminal 104 or computing device 112). In some embodiments, the equity determination may prompt an immediate alarm or indicator that is communicated to the requesting party. In some embodiments, the alarm may be communicated to any parties that may be interested in the determination (e.g., dealers and consumers). In some embodiments, this alarm may be communicated via the network 106 or via another communication method as identified by the consumer information received by the VEFS 102.

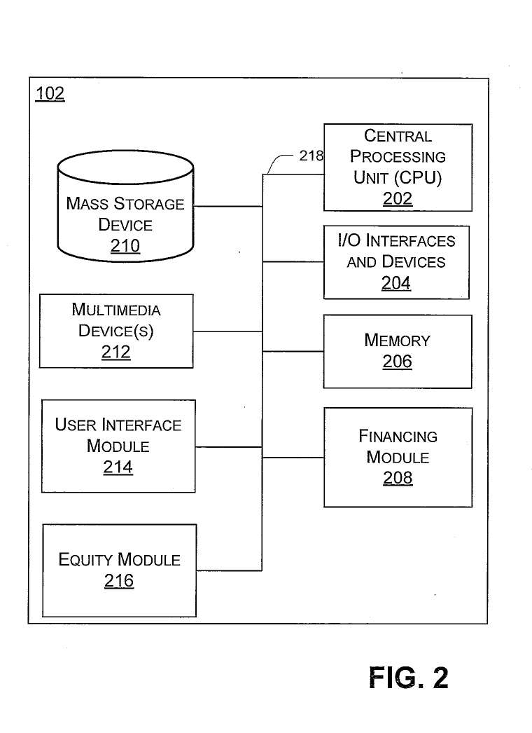

FIG. 2 is a block diagram corresponding to hardware and/or software components of an example embodiment of the VEFS 102 of FIG. 1. The hardware and/or software components as discussed below with reference to the block diagram of the VEFS 102 may be included in any of the devices of the communication system 100 (e.g., the dealer terminal 104, the computing devices 112, and the lenders systems 110). These components may be used to implement systems and methods described herein.

In some embodiments, certain modules described below, such as a user interface module 214, an equity module 216, or a financing module 208 included with the VEFS 102 may be included with or performed by different and/or multiple devices of the communication system 100. For example, certain user interface functionality described herein may be performed by the user interface module 210 of the VEFS 102 and/or by the user interface module 224 of the computing device 112.

In some embodiments, the various modules described herein may be implemented by either hardware or software. In an embodiment, various software modules included in the system 102 may be stored on a component of the system 100 itself, or on computer readable storage media separate from the system 100 and in communication with the system 100 via the network 106 or other appropriate means.

The VEFS 102 may comprise, for example, a computer that is IBM, Macintosh, or Linux/Unix compatible or a server or workstation. In some embodiments, the VEFS 102 comprises a smart phone, a personal digital assistant, a kiosk, or a media player. In some embodiments, the VEFS 102 includes one or more central processing units (“CPUs”) 202, I/O interfaces and devices 204, memory 206, financing module 208, mass storage device 210, multimedia devices 212, the user interface module 214, the equity module 212, and bus 218.

The CPU 202 may control operation of the VEFS 102. The CPU 202 may also be referred to as a processor. The CPU 202 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The I/O interface 204 may comprise a keypad, a microphone, a touchpad, a speaker, and/or a display, or any other commonly available input/output (I/O) devices and interfaces. The I/O interface 204 may include any element or component that conveys information to a consumer of the VEFS 102 and/or receives input from the consumer. In one embodiment, the I/O interface 204 includes one or more display devices, such as a monitor, that allows the visual presentation of data to the consumer. More particularly, the display device may provide for the presentation of GUIs, application software data, and multimedia presentations, for example.

In some embodiments, the I/O interface 204 may provide a communication interface to various external devices. For example, the VEFS 102 may be electronically coupled to the network 106 (FIG. 1), which comprises one or more of a LAN, WAN, and/or the Internet. Accordingly, the I/O interface 204 may include an interface allowing for communication with the network 106, for example, via a wired communication port, a wireless communication port, or combination thereof. The network 106 may allow various computing devices and/or other electronic devices to communicate with each other via wired or wireless communication links.

The memory 206, which may include both read-only memory (ROM) and random access memory (RAM), may provide instructions and data to the CPU 202. For example, inputs received by one or more components of the VEFS 102 may be stored in the memory 206. A portion of the memory 206 may also include non-volatile random access memory (NVRAM). The CPU 202 typically performs logical and arithmetic operations based on program instructions stored within the memory 206. The instructions in the memory 206 may be executable to implement the methods described herein.

The CPU 202 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The VEFS 102 may also include the mass storage device 210 for storing software or information (for example, the vehicle history reports or associated data). Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein. Accordingly, the VEFS 102 may include, e.g., hardware, firmware, and software, or any combination therein. The mass storage device 210 may comprise a hard drive, diskette, solid state drive, or optical media storage device.

The VEFS 102 includes the equity module 216. In some embodiments, the equity module 216 may be stored in the mass storage device 210 as executable software code that is executed by the CPU 202. This, and other modules in the VEFS 102, may include components, such as hardware and/or software components, object-oriented software components, class components and task components, processes, functions, attributes, procedures, subroutines, segments of program code, drivers, firmware, microcode, circuitry, data, databases, data structures, tables, arrays, and variables. In the embodiment shown in FIG. 2, the VEFS 102 is configured to execute the equity module 216 to perform the various methods and/or processes as described herein.

In some embodiments, the equity module 216 may be configured to determine equity for a vehicle owned by the consumer. In some embodiments, the equity module 216 may utilize information received from the dealer terminal 104 of FIG. 1 to determine the equity in the vehicle of the consumer. For example, the VEFS 102 may receive information that the dealer provides via the dealer terminal 104 that the dealer had from previous transactions (e.g., vehicle records of vehicles purchased from the dealer and/or loan records of loans backed or provided by the dealer). In some embodiments, the VEFS 102 may receive the information for use in determining the equity in the vehicle from one or more third party databases, such as the lender systems 110, the vehicle history data store 108, or credit information databases, which may provide various information from which vehicle equity may be determined.

For example, the VEFS 102 may receive information regarding the consumer's vehicle loan (e.g., original loan balance, quantity and amount of payments since origination, etc.) from lender records or credit history information and use this information to generate an estimate of equity in the consumer's vehicle. In some embodiments, the VEFS 102 may receive vehicle information, such as the vehicle VIN or consumer information directly from the consumer, for example via the computing devices 112. Any or all of this information may be used to generate the equity information of the consumer's vehicle. This equity information may later be used in credit offers or other financing determinations as described herein. In some embodiments, the equity information may be used to place the consumer in one or more tiers with regards to prequalification for the credit offer. In some embodiments, the equity information may be used to determine a potential down payment by the consumer.

In some embodiments, the equity module 216 may identify a request for the equity determination as received from the dealer or a lender. The existing equity that the customer acquired in one or more vehicles may be a factor used in a determination of whether or not the dealer or lender can extend an offer of credit to the consumer. In some embodiments, the request for the equity determination may include any of the information discussed herein. In some embodiments, the equity module 216 may use the information received to calculate or identify the vehicle equity or extrapolate additional information. The request may request all acquired and determined or identified data and/or records associated with the vehicle equity to be returned to the VEFS 102 (e.g., for storage in the mass storage device 210).

The VEFS 102 includes the financing module 208. In some embodiments, the financing module 208 may be stored in the mass storage device 210 as executable software code that is executed by the CPU 202. This, and other modules in the VEFS 102, may include components, such as hardware and/or software components, object-oriented software components, class components and task components, processes, functions, attributes, procedures, subroutines, segments of program code, drivers, firmware, microcode, circuitry, data, databases, data structures, tables, arrays, and variables. In the embodiment shown in FIG. 2, the VEFS 102 is configured to execute the financing module 208 to perform the various methods and/or processes as described herein.

In some embodiments, the financing module 208 may be configured to identify a request, as received from the dealer using the dealer terminal 104 of FIG. 1 or from the consumer interacting with a dealer website or lender's widget, for a prequalification determination of the consumer with regard to a credit or other financing offer. In some embodiments, the request for the prequalification determination may include vehicle information as well as information about the consumer (e.g., personal information, financial information, etc.) and the consumer identifier that identifies the consumer at the basis of the prequalification determination. In some embodiments, the consumer information may be saved as part of a consumer profile, for example, as associated with a consumer account with the dealer or the lenders. Similarly, in some embodiments, the vehicle information and/or the equity information may be saved as part of the consumer profile or as part of a vehicle profile. Accordingly, when the consumer information is part of the consumer profile and the vehicle information is part of the vehicle or consumer profiles, the prequalification determination request may not include receiving the personal information from the consumer, but rather from the dealer terminal 104, the computing device 112, or the lender system(s) 110.

In some embodiments, the financing module 208 may receive the prequalification determination request from the consumer and communicate the request to one or more of the lender systems 110 (along with the associated consumer information) for the lenders themselves to determine. In some embodiments, the financing module 208 may receive prequalification criteria from the lender systems 110 and/or the dealer terminal 104. The financing module 208 may be configured to apply the information received in the prequalification determination request to the prequalification criteria received from the lender systems 110 or the dealer terminal 104 to generate the requested prequalification determination. In some embodiments, the financing module 208 may request the dealer or the lender identify or select various criteria and/or tiers used in the prequalification determination. The prequalification determination request may request affirmation or denial from the consumer regarding whether or not the consumer is prequalified for one or more selected financing offers. For example, when creating the servicing appointment for their vehicle, or when interacting with the widget (or similar component), the consumer may indicate their approval or agreement to participate in the prequalification determination. To determine if the consumer qualifies for a financing offer as presented by one or more lenders and/or the dealer, the prequalification determination may be individually generated for each of the one or more financing offers.

In some embodiments, the prequalification determination for a financing offer may be less detailed and less invasive (e.g., requiring less confidential consumer information) than a formal application process for the same financing offer. In one embodiment, the financing module 208 disclosed herein performs pre-qualification decisioning for the consumer based on levels or tiers of credit.

When the lenders and/or dealers determine the result of the prequalification determination request, the result(s) may be communicated back to the financing module 208 (e.g., via the I/O interfaces and devices 204). In some embodiments, the prequalification determination result may be communicated to the consumer in person or via communications (e.g., mail, phone, e-mail, etc.). For example, in some embodiments, the result of the prequalification determination request may be a simple “Yes” or “Prequalified” or “Approved” or “No” or “Denied”, among others.

The VEFS 102 also includes the user interface module 214. In some embodiments, the user interface module 214 may also be stored in the mass storage device 210 as executable software code that is executed by the CPU 202. In the embodiment shown in FIG. 2, the VEFS 102 may be configured to execute the user interface module 214 to perform the various methods and/or processes as described herein.

The user interface module 214 may be configured to generate and/or operate user interfaces of various types. In some embodiments, the user interface module 214 constructs pages or displays to be displayed in a web browser or computer/mobile application. In some embodiments, the user interface module 214 may provide an application or similar module for download and operation on the dealer terminal 104 and/or the computing devices 112, through which the dealer/consumer and the VEFS 102 may interact. The pages or displays may, in some embodiments, be specific to a type of device, such as a mobile device or a desktop web browser, to maximize usability for the particular device. In some embodiments, the user interface module 214 may also interact with a client-side application, such as a mobile phone application (an “app”), a standalone desktop application, or user communication accounts (e.g., e-mail, SMS messaging, etc.) and provide data as necessary to display vehicle equity and prequalification determinations.

For example, as described herein, the VEFS 102 may be accessible to the consumer via a website (e.g., the dealer's website or the lender's website) which may include a banner ad or widget for prequalification. The banner ad may be included in a vehicle inventory listing page or in a vehicle service request page, for example. The consumer may opt into the pre-qualification decisioning process by providing information including name, address, or the like. In some embodiments, the consumer may also provide their consent. The widget associated with the website may provide the consumer information and consent to the VEFS 102. Depending on whether the consumer passes one of several tiers or levels of credit qualification, the financing module 208 may generate a decision regarding the prequalification. The decision may include whether or not the consumer passes, and also, details about which tier or criteria the consumer meets or qualifies for (e.g., segments, etc.). The segments and elements determined may then be used by the VEFS 102 to make equity and/or payment calculations (e.g., via the equity module 216). When the financing module 208 determines the consumer passes one or more of the credit tiers, the financing module 208 may notify the consumer of an offer and potential payment based on their equity via the dealer or via the lender, depending on the entity that backs the financing offer. When the consumer is determined not to meet the necessary criteria, the no pass decision is also communicated to the consumer. A pre-qualified consumer may then visit a vehicle dealer to redeem their offer. A non-qualified consumer may be notified that there are no offers available, but that the vehicle dealer may contact them with other options.

In some embodiments, these communications may be made automatically once the prequalification determination is made. In some embodiments, these communications may be specially formatted to be simultaneously communicated to the consumer via multiple communications methods and/or formats (e.g., text, e-mail, call, mail, etc.) so the consumer may receive the prequalification determination promptly.

In another embodiment, the financing module 208 (or other module of the VEFS 102) disclosed herein performs pre-qualification decisioning for consumers that are scheduled to visit the dealer. As described herein, the pre-qualification decision may be based on levels or tiers of credit. The VEFS 102 (e.g., via the CPU 202 or the I/O interfaces and devices 204) may receive a batch file including consumers scheduled for visits on a particular day with the dealer, for example the following day. The VEFS 102 (e.g., via the CPU 202) may integrate batch files received from several dealers. The VEFS 102 may make a determination on whether each of the consumers pass one of several tiers or criteria of credit qualification, and a decision regarding the prequalification of each of the consumers may be made (e.g., by the financing module 208). The decision may include whether or not the consumer passes, and also, details about the segment may be included. The segments determined may then be used by the VEFS 102 to make equity and/or payment calculations (e.g., via the equity module 216). The VEFS 102 may also use information relating to vehicle history reports and credit information to determine the consumers' existing equity in vehicles in their possession. Once the consumer prequalification tiers and existing equities are determined, a list of the consumers' information is sent to the respective dealers. The dealers, or other third parties, may then provide firm offers of credit to the consumers that were prequalified.

In some embodiments, one or more windows or interactions between the VEFS 102 and the consumer may involve a lightbox or overlay layer. For example, a lightbox or overlay may comprise a format that displays images and/or videos and text or prompts by filling the screen, and dimming out the rest of the web page or display. The lightbox or overlay may, alternatively, or additionally, places a new set of images, information, or prompts over existing data while maintaining the existing data though it is covered (and thus not viewable) while the new set of information is visible. For example, the overlay or lightbox may be used to present the initial widget and/or browsing object.

The VEFS 102 may also include one or more multimedia devices 212, such as speakers, video cards, graphics accelerators, and microphones, for example.

The various components of the VEFS 102 may be coupled together by a bus system 218. The bus system 218 may include a data bus, for example, as well as a power bus, a control signal bus, and a status signal bus in addition to the data bus. In different embodiments, the bus could be implemented in Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of VEFS 102 may be combined into fewer components and modules or further separated into additional components and modules than that shown in FIG. 2.

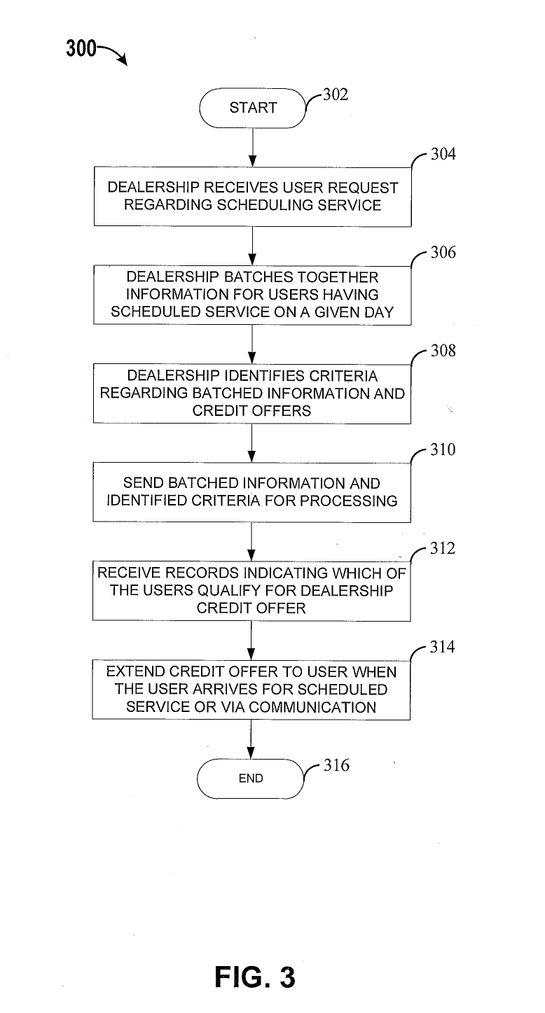

FIG. 3 is a process flowchart illustrating an example method of generating a prequalification determination and vehicle equity determination based on the consumer request. Method 300 is an exemplary description of a method that may involve the dealer (e.g., the dealer terminal 104) and the VEFS 102. Methods similar to method 300 may be run simultaneously, in an overlapping manner, or sequentially for multiple dealers at multiple locations that are each accessing the VEFS 102 via one or more dealer terminals 104. In some embodiments, particular steps of the method 300 may be implemented by the CPU 202, as referenced in FIG. 2. In some embodiments, one or more of the steps of the method 300 may be implemented by one or more of the components of the VEFS 102, as referenced in FIGS. 1 and 2. In some embodiments, the blocks of the method 300 may be performed in a sequential manner, while in other embodiments, the blocks of the method 300 may be performed in a non-sequential manner, regardless of the terminology used to describe the method 300 herein. In some embodiments, each of the blocks of method 300 may be performed by a single entity (e.g., dealer, lender, vehicle listing site, credit bureau, etc.) or multiple entities.

At block 304, the dealer receives a consumer request to schedule service for a vehicle. In some embodiments, the vehicle may be a vehicle owned or leased by the consumer. In some embodiments, the consumer request may be received from the computing device 112a, via the network 106, at the dealer terminal 104. In some embodiments, the consumer request may comprise a date and/or time at which the consumer wishes to visit the dealer to have the vehicle serviced. The consumer request may also provide the dealer terminal 104 with vehicle information (e.g., related to the vehicle to be serviced) and/or consumer information (e.g., personal information, credit information, etc.). In some embodiments, the consumer request for scheduling service may be associated with a consumer account with the dealer that includes previous records and information associated with the consumer based on previous transactions between the dealer and the consumer.

In some embodiments, in response to the consumer request, the consumer is presented with a prompt to input information regarding a prequalification determination for one or more available financing offers. In some embodiments, the prompt may be presented to the consumer based on the consumer requesting to schedule service for a particular vehicle or for a particular day or date (e.g., if the dealer has specific goals at different times). In some embodiments, the prompt may be presented to the consumer based on the consumer selecting a link or button to schedule the service or signing into an account. In some embodiments, the prompt may request the consumer provide information regarding the type of financing offer the consumer desires and/or information that may be used to determine creditworthiness or financing prequalification approvals.

At block 306, the dealer batches together all of scheduled service information for a given day. For example, if the dealer has twenty appointments scheduled for a given day, the dealer may batch together the information regarding the twenty vehicles to be serviced as well as the twenty consumers for the vehicles (assuming each vehicle is owned by a different consumer). In some embodiments, batching the service information may comprise aggregating all the information received from the consumer regarding the scheduled service (e.g., vehicle information, consumer information, etc.). In some embodiments, batching the service information may comprise extracting pertinent information from the information received as part of the consumer request for scheduled service. In some embodiments, the pertinent information may include information such as VINs of the scheduled vehicles, in service or loan origination or purchase dates for the scheduled vehicles, and consumer information that will enable a credit check. In some embodiments, the pertinent information may include opt-in information from the consumer of a scheduled vehicle, where the opt-in information indicates whether the consumer is willing to receive credit or financing offers. For example, if the consumer has opted in, then the dealer may include that consumer's information and/or vehicle information in the batched information. If the consumer has not opted in, then the dealer may not include that consumer's information or vehicle information in the batched information. In some embodiments, the dealer terminal 104 may perform the step of block 306 (for example, via the CPU 202 and/or memory 206 of the dealer terminal 104, as described above).

At block 308, the dealer identifies criteria regarding batched information and credit offers (e.g., via the dealer terminal 104). For example, the dealer may establish minimum criteria or a threshold below which the dealer will not provide financing or credit offers. In some embodiments, the criteria and/or threshold information may be preset. In some embodiments, the criteria and/or threshold may vary day-to-day based on dealer preferences. In some embodiments, the dealer may provide consumer specific criteria and/or thresholds based on prior relationships with the consumer, vehicle(s) owned by the consumer, or other consumer specific information of which the dealer is aware. As discussed herein, the dealer may be replaced by the lender.

At block 310, the dealer may send the batched information and the identified criteria and/or threshold information for processing. In some embodiments, the dealer may send the information and criterion via the network 106 from the dealer terminal 104 to the VEFS 102. In some embodiments, the VEFS 102 may be separated into two separate components. When the VEFS 102 is split into one component that performs equity determinations and another component that performs financing determinations, the dealer may send the batched information to the separate components. Accordingly, the dealer may send the identified criteria and/or threshold information to both the equity computing and financing computing components.

At block 312, the dealer receives the results of the prequalification and equity determinations. In some embodiments, the dealer may receive records of those consumers who are approved for the financing or credit offer. In some embodiments, the dealer may receive records of those consumers who are not approved for the financing or credit offer. For example, the records of the consumers that the dealer receives may comprise the records of the vehicles and/or consumers from the dealer's batched information that meet the identified criteria and/or threshold information. In some embodiments, the dealer may also receive the equity determination for the vehicles. The equity determinations may comprise amounts of equity each vehicle of the batched information was determined to have. For example, if one of the vehicles had no equity, the dealer may receive an amount of $0. Thus, the equity determinations received may comprise dollar values. In some embodiments, the equity determinations received may correspond to fractional or relational values based on the original purchase price, based on a current value, or based on a standard price point. For example, the equity determination may indicate that a vehicle has equity of half its original purchase price or half a value of a similar car if purchased used today.

At block 314, the dealer may use the received prequalification and equity determinations and/or the received records to extend credit or financing offers to those consumers that were approved or to consumers that the dealer believes would be a worthy credit recipient. In some embodiments, if the consumer is prequalified, the dealer may use the vehicle equity determination to decide an amount of credit to extend to the consumer. In some embodiments, the dealer may integrate the credit offer with a report regarding the scheduled service (e.g., as a portion of the receipt or as a separate page of a work performed document). In some embodiments, the equity determination for the vehicle may also be presented in the service records (e.g., as a line item on a receipt). In some embodiments, the prequalification and/or equity determination may trigger an indicator on a check-in or other computer screen at the dealer. In some embodiments, the different tiers of prequalification may each trigger a specific identifier. Similarly, there may be multiple tiers of prequalification and/or vehicle equity (e.g., corresponding to vehicle dollar values or relationships between vehicle value and equity), and the prequalification/equity determination may trigger a specific identifier based on the particular prequalification/equity determination.

These indicators may allow the dealer to present the proper consumers with customized credit offers based on the indicators. In some embodiments, the prequalification and equity determinations may be used to generate indicators in the consumer's account with the dealer. In some embodiments, the prequalification/equity determination may be used to filter what vehicles are shown and/or offered to the consumer, as certain vehicles available may be more expensive than the consumer is prequalified for.

In some embodiments, the credit offers, the prequalification determination, and the equity determinations may be provided to the consumer in person during their scheduled service (e.g., as the report described above). In some embodiments, the offers and determinations may be communicated to the consumer, for example via e-mail or standard mail. In some embodiments, the prequalification and equity determinations may be used to generate indicators in the consumer's account with the dealer.

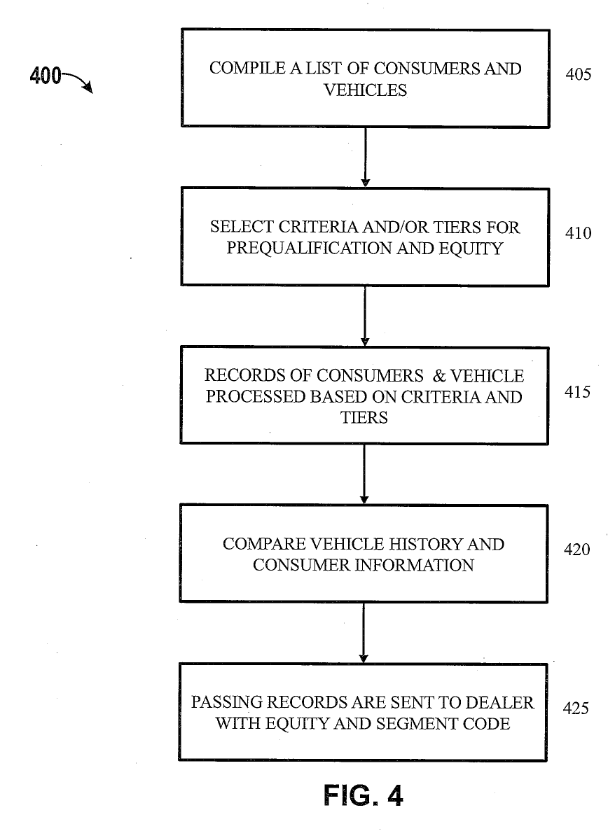

FIG. 4 is a process flowchart illustrating an example method 400 of generating a prequalification determination and an equity determination for credit offers by a dealer or lender. Various steps of the blocks of the method 400 may be performed by various entities and/or components of the system 100. The method 400 may be executed, for example, by one or more modules of the VEFS 102, such as the user interface modules 210, the equity module 216, the financing module 208, and/or the processor 202. In some embodiments, the method 400 may be executed by one of the other components of the system 100 of FIG. 1 or by a combination of components of the system 100 of FIG. 1. In various embodiments, fewer blocks or additional blocks may be included in the method 400, or various blocks may be performed in an order different from that shown in FIG. 4. In some embodiments, the blocks of the method 400 may be performed in a sequential manner, while in other embodiments, the blocks of the method 400 may be performed in a non-sequential manner, regardless of the terminology used to describe the method 400 herein. In some embodiments, one or more of the blocks of the method 400 may be performed in the background or parallel with other blocks of the method 400. In some embodiments, each of the blocks of method 400 may be performed by a single entity (e.g., dealer, lender, vehicle listing site, credit bureau, etc.) or multiple entities.

Beginning at block 405, a dealer may compile a list of all consumers and vehicles that are scheduled to visit the dealer for servicing on a given day. The given day may be the next day or may be a day further in the future. This list may be compiled using the dealer terminal 104. In some embodiments, two lists may be compiled, one including the consumers only and the other including both the consumers and the vehicles. The list (or lists) may then be submitted to the respective components of the system 100 that will perform the desired determination (prequalification or equity). In some embodiments, this will be the VEFS 102, though, as described herein, the functionalities of the VEFS 102 may be split between two or more components.

At block 410, the criteria for the prequalification and/or the equity determination are selected. In some embodiments, the criteria may be automatically selected based on the party backing or providing the credit offers. For example, a dealer may have pre-established criteria different from the pre-established criteria of a 3^{rd} party lender. In some embodiments, the dealer selects the criteria when the dealer submits the list or lists. In some embodiments, the criteria may be divided into tiers. The tiers may qualify different levels of criteria. For example, if there are four tiers, the tiers may be arranged from least to greatest numbers of criteria, where each tier corresponds to different combinations of criteria. In some embodiments, the tiers may be cumulative, where a higher tier includes the criteria of all lower tiers plus at least one additional criterion. In some embodiments, the tiers may correspond to different credit scores, where a higher credit score results in placement in a higher tier. Accordingly, the dealer and/or lender may select one or more tiers that would qualify for the credit offer, which inherently selects the corresponding criteria. The selected criteria or tiers may be communicated to the components performing the prequalification and equity determinations, such as the VEFS 102.

At block 415, records of the consumers and/or vehicles on the list(s) are processed based on the tiers and/or criteria. The processing may comprise reviewing information for the consumers and/or vehicles as described herein to determine whether the consumers are prequalified for any financing or credit offers based on the criteria and tiers selected by the dealer. As described herein, the processing may generate lists of consumers and/or vehicles that pass or meet selected criteria and/or tiers. In some embodiments, the consumer information may first be processed according to the prequalification criteria or tiers, and only those consumers that pass the prequalification processing have corresponding vehicles processed for equity determinations. Accordingly, the amount of processing is reduced by only determining the equity in vehicles for the passing consumers as opposed to all the vehicles of the list.

At block 420, the vehicle history and consumer records are compared to ensure that the consumer is the owner of the vehicle. In some embodiments, the VEFS 102 may compare consumer credit records to identify if the consumer makes payments and has loans or debts corresponding to registration events of the vehicle. For example, the credit information for the consumer may be reviewed to determine a start date for a vehicle loan, while the corresponding vehicle history information may be reviewed to determine a registration and/or a purchase date. These dates from the consumer and vehicle history information are then compared to determine whether they are within a given range. In some embodiments, the consumer credit information includes a vehicle loan amount, and this information may be used to calculate the vehicle valuation for use in determining the equity in the vehicle. In some embodiments, the equity may be negative (e.g., more is owed on the vehicle than it is worth) or positive (the vehicle is worth more than is owed).

At block 425, the passing records with the segment code (e.g., the indicator regarding which tier or criteria the consumer is in) with the equity calculation are sent to the dealer (or lender or vehicle listing website). The dealer or lender may then extend offers of credit to those consumers in the passing records, and the method 400 ends with the communication of the offer to the consumers.

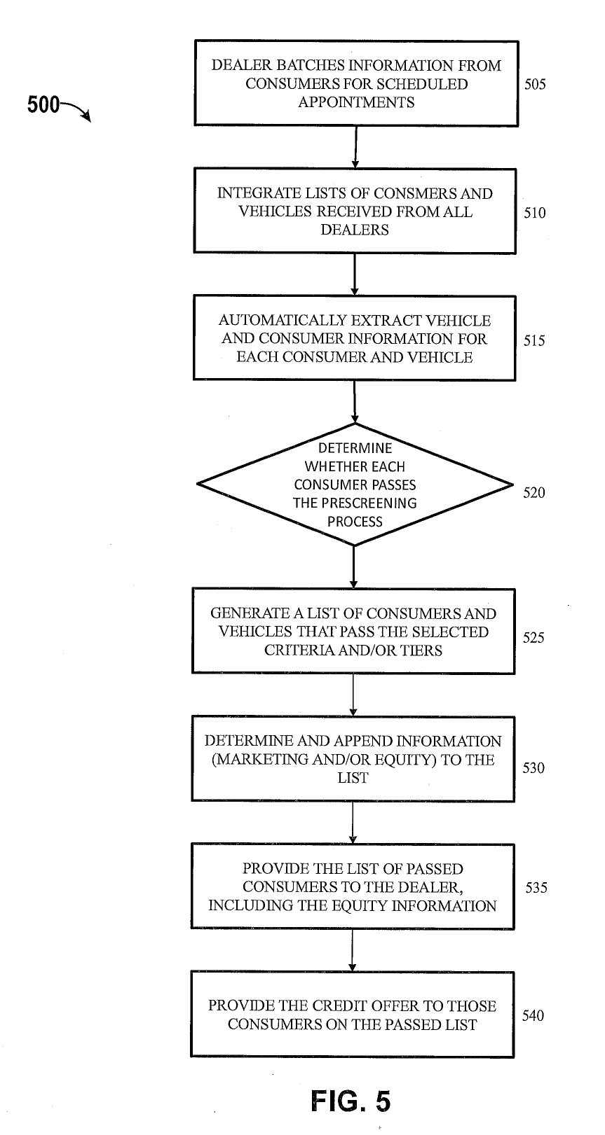

FIG. 5 depicts a processor flow diagram for a method 500 of generating and providing prequalification and equity information. In some embodiments, the method 500 may be performed by one or more of the components of the system 100. In some embodiments, each of the blocks of method 500 may be performed by a single entity (e.g., dealer, lender, vehicle listing site, credit bureau, etc.) or multiple entities.

At block 505, the dealer may batch information from consumers that have scheduled service appointments for a given day. As discussed above, the batch information may include information about the consumers (e.g., name, address, etc.) and/or vehicle information (e.g., VIN, mileage, etc.). The batched information may be submitted to one or more systems or servers to determine prequalification and equity information, such as the VEFS 102 of FIG. 1. In some embodiments, the batched information may also include the dealer selected criteria and/or tier information for use in the prequalification and equity determinations.

At block 510, the VEFS 102 may integrate lists it receives from multiple dealers. Integrating lists from multiple dealers may allow the VEFS 102 to automatically perform the prequalification and equity determinations on a large quantity of vehicles and consumers.

At block 515, the VEFS 102 begins an automated prescreen process. In some embodiments, the automated prescreen process may comprise the VEFS 102 extracting information from the batched information received from the one or more dealers. In some embodiments, the VEFS 102 may automatically extract information for the prequalification and equity determinations. For example, when performing the prequalification determination, the VEFS 102 may automatically extract the consumer information provided in the batched information and use the extracted consumer information to obtain consumer credit information from the consumer credit data store 114. The VEFS 102 may then use the obtained information to perform the prequalification determination based on the selected criteria and/or tiers.

Similarly, the VEFS 102 may automatically extract the vehicle information provided in the batched information and use the extracted vehicle information to obtain vehicle history information from the vehicle history data store 108. The VEFS 102 may use the obtained information to perform the equity determination based on the selected criteria and/or tiers

At block 520, the VEFS 102 may determine whether each consumer and vehicle on the lists from the dealers pass the prescreening process. In some embodiments, passing the prescreening process may comprise the consumer having credit information that meets the dealer selected criteria and/or tiers and the vehicles having equity that meets the dealer selected criteria and/or tiers.

At block 525, the VEFS 102 may generate a list of consumers and vehicles from the batched information received from the dealers that that are determined to meet the dealer selected criteria and/or tiers. This list may comprise a prescreen list. At block 530 of the method 500, the VEFS 102 may append marketing information to the prescreened list and/or perform an equity calculation for the vehicles of the prescreened list of consumers. Performing the equity calculation only on those consumers having met the dealer selected criteria and/or tiers may reduce the resource expenditures that may be involved if all vehicles from the dealer batched information were subjected to the equity determination or calculation. At block 535, the VEFS 102 may provide the list of prequalified consumers to the dealer, the list also including vehicle equity calculations as described above. The dealers may then use this list to identify which consumers are to receive credit offers. If the consumer arrives for the scheduled service appointment, the dealer may provide the credit offer to the consumer directly at block 540. If the consumer does not arrive for the scheduled service appointment, the dealer may send the credit offer to the consumer in the mail.

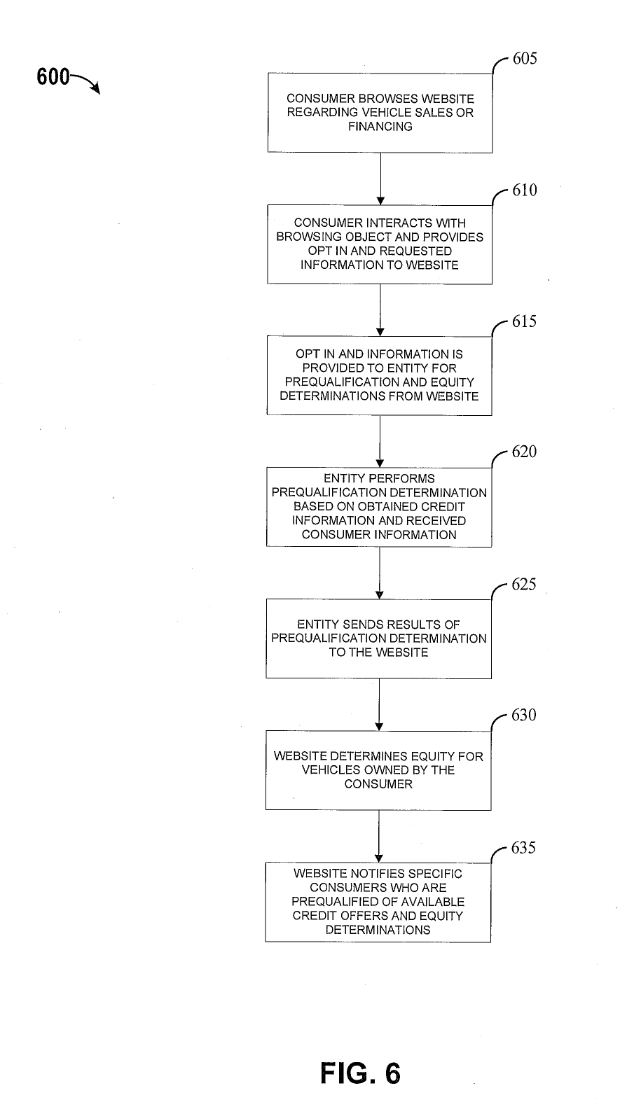

FIG. 6 depicts a process flow diagram for another method 600 of generating and providing prequalification and equity information. Various steps of blocks of the method 600 may be performed by various components of the system 100 of FIG. 1. For example, consumers may access the system 100 using the computing devices 112, while the dealers may access the system 100 via the dealer terminals 104. The prequalification and equity determinations may be performed by the VEFS 102 based on information received, as described herein. In some embodiments, each of the blocks of method 500 may be performed by a single entity (e.g., dealer, lender, vehicle listing site, credit bureau, etc.) or multiple entities.

In some embodiments, the system 100 may be integrated with a web-based or internet-based system. For example, the system 100 may be accessible via a dealer website or a vehicle listing website. In such an embodiment, at block 605, a consumer may log onto a dealer website (or other vehicle listing website or lending website) when browsing vehicles to purchase or lease or when looking to schedule service for a vehicle the consumer already owns or leases. The consumer may be browsing the website via the computing device 112, and the website may be hosted by the dealer (e.g., via the dealer terminal 104 or a dealer server not shown). In some embodiments, the website may be hosted by a third party (e.g., a lender, a vehicle listing entity or a search entity). While browsing the website, the consumer may access a banner ad, a widget, or any other browsing object at block 610. The ad (or widget or other browsing object) may indicate that the consumer can find out about loan or credit offer prequalification for use in the purchase or lease of a new (or used) vehicle. By clicking or otherwise accessing the ad, the consumer may be asked to opt in to the prequalification and/or equity determination and/or may be asked to provide personal information and/or vehicle information used to make the prequalification and/or vehicle equity determinations.

At block 615, the opt in information and the personal and/or vehicle information may be provided from a company hosting the website or the browsing object (e.g., from the dealer, lender, etc.) to an entity that performs the prequalification and/or vehicle equity determinations. In some embodiments, when this information is passed to the entity, the dealer may provide its prequalification criteria and/or tier information to the entity. In some embodiments, the company hosting the website or the browsing object may not send any vehicle information to the entity and instead keep the vehicle information for processing of the vehicle equity determination at a later time.

At block 620, the entity performs the prequalification determination based on the received consumer information and the criteria and/or tiers received from the website or company. In some embodiments, the entity may be a credit bureau or other entity having access to consumer credit information. In some embodiments, the entity may comprise one or more businesses hosting the consumer credit data stores 114 of FIG. 1. In some embodiments, the entity may take the consumer information of each consumer received from the website company and obtain their credit information (e.g., from the consumer credit data store 114). This credit information may then be used in comparison with the criteria and/or tier information received from the browsing object company to determine if each consumer “passes” or “fails” the prequalification determination. If the entity determines that a specific consumer does not pass the prequalification determination, the entity indicates that to the company. If the entity determines that a specific consumer does pass the prequalification determination, the entity indicates that to the company as well.

At block 625, the entity may send the results of the prequalification determinations to the website company. In some embodiments, the results may comprise two lists, a passing list and a not passing list. For the passing list, the entity may indicate to the website company which criteria and/or tier the particular consumer qualified, which may enable the website company to determine the offers for which the consumer qualifies.

At block 630, for consumers that are on the passing list, the website company may determine equity for vehicles that are owned by the consumer. In some embodiments, the equity determination may be based on vehicle information received from the consumer. In some embodiments, the vehicle equity determination may be based on vehicle information obtained using the consumer's information and searching vehicle history databases. In some embodiments, such a search may result in multiple vehicles being identified for each consumer, and the equity determinations may be made for each identified vehicle. In some embodiments, the equity determinations may be made by a third party website or source having access to the vehicle history data sources 108 or by the entity that performed the prequalification determination. In some embodiments, the equity information may be calculated as potential collateral or to determine available down payment of the consumer.

At block 635, the website company may notify passing consumers of available credit offers and vehicle equity determinations for vehicles owned by the consumers. The consumers receiving such notifications may contact the dealer or lender to redeem the offers.

At block 640, for consumers that are on the not passing list, the website company may provide an indication (to the consumer) that there are no available offers for the consumer at that time and invite the consumer to check back at a later date.

In some embodiments, when the consumer is visiting a dealer's website or vehicle listing website, the website may use the consumer's credit determination to automatically filter vehicles that are shown to the consumer. The vehicles may be filtered so the consumer only sees vehicles available via the dealer or the listing website for which the consumer is preapproved. This may allow both the dealers and the consumer to save time by not viewing vehicles for which the consumer is not qualified to purchase.

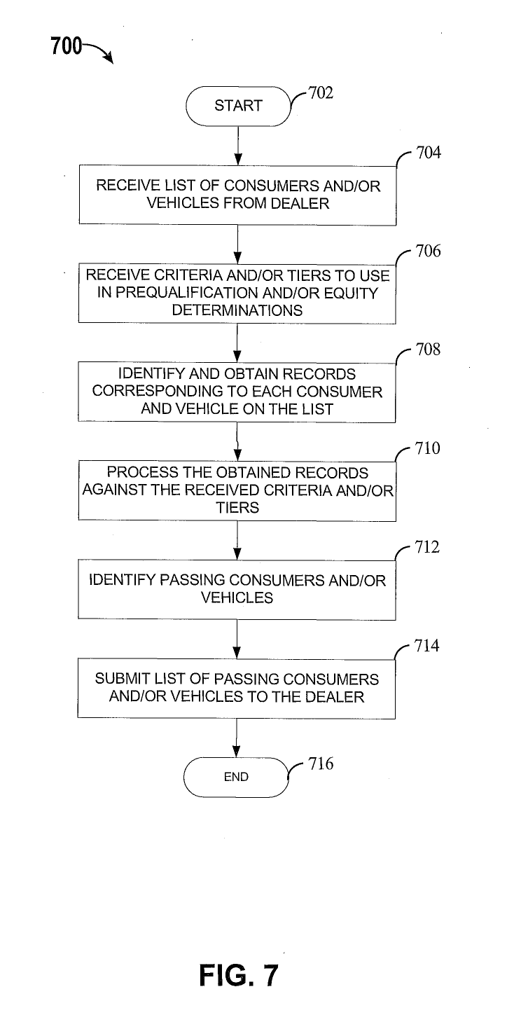

FIG. 7 shows a process flow diagram of a method 700 of performing prequalification and equity determinations based on received information, and then returning results to a requesting entity. In some embodiments, the method 700 may be performed by one or more components of the system 100, for example, the VEFS 102. In some embodiments, the method 700 may be performed by any other components of the system 100. In some embodiments, each of the blocks of method 700 may be performed by a single entity (e.g., dealer, lender, vehicle listing site, credit bureau, etc.) or multiple entities.

The method 700 starts at block 702 and proceeds to block 704, where the VEFS 102 receives a list of consumers and/or vehicles from a dealer or other request entity (such as a lender, a consumer, or a vehicle listing website). The I/O interfaces and devices 204 may receive the list. Once the list is received, the VEFS 102 may further receive a selection of criteria and/or tiers as selected by the dealer at block 706. In some embodiments, as discussed herein, the selection of criteria and/or tiers may comprise the minimums that must be met for a consumer and/or vehicle to be determined to be prequalified. Once the VEFS 102 has received the selection of criteria and/or tiers and the list of consumers and/or vehicles, the VEFS 102 may identify and obtain credit history records of the consumers on the list at block 708. In some embodiments, the VEFS 102 may obtain vehicle history records for the vehicles on the list, though in some embodiments, the vehicle history records may be obtained after the credit history records have been processed.

At block 710, the VEFS 102 processes the credit history records of the consumers against the received selections of criteria and/or tiers. Details of this comparison are described throughout this document. In some embodiments, where the vehicle history records were obtained at block 708, the VEFS 102 may also determine the equity in each vehicle on the list. The equity may be determined based on the criteria selected by the dealer, which may include determining the equity in relation to the original purchase price, a current value of the vehicle, or a set value. Where the credit history record corresponding to a particular consumer is determined to pass, satisfy, or exceed the selected criteria and/or tiers, the VEFS 102 identifies the consumer as “passing” at block 712. Similarly, where the vehicle history record corresponding to a particular vehicle is determined to pass, satisfy, or exceed the selected criteria and/or tiers, the VEFS 102 identifies the vehicle as having a positive or negative equity and may provide a corresponding value or relationship of the vehicle at block 712. In some embodiments, where the VEFS 102 does not identify and obtain the vehicle history records of the vehicles on the list, the VEFS 102 may wait to identify and obtain the vehicle history records of only vehicles for passing consumers. This may reduce the number of vehicles that the VEFS 102 must compare and thus reduce processing time of the VEFS 102. Once the VEFS 102 generates the list of passing consumers and/or vehicles, the VEFS 102 then submits the list of passing consumers and/or vehicles to the dealer (or other requesting entity) at block 714, before the method 700 ends at block 716.

Any discussions of dealers herein can be replaced with any one of a consumer, a vehicle listing website, a lender, or any similar entity involved in vehicle sales and/or records. Furthermore, any discussions including combinations of one or more dealers, lenders, third parties, etc., herein may be replaced with a single entity performing the steps described as being performed by multiple entities.

Any of the components or systems described herein may be controlled by operating system software, such as Windows XP, Windows Vista, Windows 7, Windows 8, Windows Server, UNIX, Linux, SunOS, Solaris, iOS, Android, Blackberry OS, or other similar operating systems. In Macintosh systems, the operating system may be any available operating system, such as MAC OS X. In other embodiments, the VEFS 102 may be controlled by a proprietary operating system. Conventional operating systems control and schedule computer processes for execution, perform memory management, provide file system, networking, I/O services, and provide a user interface, such as a graphical user interface (“GUI”), among other things.

In some embodiments, data stores and/or databases described herein may be implemented using a relational database, such as Sybase, Oracle, CodeBase and Microsoft® SQL Server as well as other types of databases such as, for example, a flat file database, an entity-relationship database, and object-oriented database, and/or a record-based database.

Computing devices, which may comprise the software and/or hardware described above, may be an end user computing device that comprises one or more processors able to execute programmatic instructions. Examples of such computing devices are a desktop computer workstation, a smart phone such as an Apple iPhone or an Android phone, a computer laptop, a tablet PC such as an iPad, Kindle, or Android tablet, a video game console, or any other device of a similar nature. In some embodiments, the computing devices may comprise a touch screen that allows a user to communicate input to the device using their finger(s) or a stylus on a display screen.

The computing devices may also comprise one or more client program applications, such as a mobile “app” (e.g. iPhone or Android app) that may be used to visualize data, and initiate the sending and receiving of messages in the VEFS 102. This app may be distributed (e.g. downloaded) over the network to the computing devices directly from the VEFS 102 (e.g., the user interface module 214 or the storage device 210) or from various third parties such as an Apple iTunes or Google Play repository or “app store.” In some embodiments, the application may comprise a set of visual interfaces that may comprise templates to display vehicle history reporting and financing information. In some embodiments, as described above, visual user interfaces may be downloaded from another server or service, such as the VHPS 106. This may comprise downloading web page or other HTTP/HTTPS data from a web server and rendering it through the “app”. In some embodiments, no special “app” need be downloaded and the entire interface may be transmitted from a remote Internet server to computing device, such as transmission from a web server that is a part of the VEFS 102 to an iPad, and rendered within the iPad's browser.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the vehicle history reporting and financing system 100, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

In some embodiments, the system distinguishes between the initial transmission of loan application data required for user interfaces, and subsequent transmissions of user interface data so that it may transmit only portions that are necessary to update a vehicle history reporting and financing user interface. This may be done, for example, using an XMLHttpRequest (XHR) mechanism, a data push interface, Asynchronous JavaScript and XML (“Ajax”), or other communication protocols.

Each of the processes, methods, and algorithms described in the preceding sections may be embodied in, and fully or partially automated by, code modules executed by one or more computer systems or computer processors comprising computer hardware. The code modules may be stored on any type of non-transitory computer-readable medium or computer storage device, such as hard drives, solid state memory, optical disc, and/or the like. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, for example, volatile or non-volatile storage.

The various features and processes described above may be used independently of one another, or may be combined in various ways. All possible combinations and sub combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and partially or fully automated via, software code modules executed by one or more general purpose computers. For example, the methods described herein may be performed by the vehicle history reporting and financing system 100, consumer computing device 162, and/or any other suitable computing device. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A consumer prequalification and vehicle equity determination system, comprising:
a communication circuit configured to communicate via a communication network;
a memory; and
a processor configured to:
provide an interface for operation at a remote computing device over the communication network,
receive, via the interface, a first list of one or more consumers, the first list comprising at least a first name of and a last name of at least one consumer on the list and at least one vehicle owned by the at least one consumer on the list, the at least one vehicle on the first list identified by at least one of a vehicle identification number (VIN), license plate number, or other unique identifier;
receive one or more criteria for determining a prequalification status of the at least one consumer on the first list;
identify which consumers of the first list have credit history records that satisfy the one or more criteria;
calculate vehicle equity values for the at least one vehicle on the first list based on vehicle history records and the credit history record of a corresponding owning consumer on the first list;
generate a second list of consumers based on comparison of credit history records and received one or more criteria and vehicles based on the calculated vehicle equity values; and
convey the second list via the interface.

2. The system of claim 1, wherein the one or more criteria is received via the interface and wherein the one or more criteria are selected based on lender or underwriter requirements, guidelines, or scoring models.

3. The system of claim 1, wherein the processor is further configured to obtain vehicle history records for the at least one vehicle on the first list corresponding to consumers identified as having credit history records satisfying the one or more criteria.

4. The system of claim 1, wherein the processor is further configured to generate the second list comprising only those consumers identified as having credit history records satisfying the one or more criteria and vehicles associated with those consumers.

5. The system of claim 1, wherein the received one or more criteria comprises a plurality of tiers, wherein at least one tier of the plurality of tiers includes different criteria and wherein identification of which consumers of the first list have credit history records that satisfy the one or more criteria comprises identifying which tier of the plurality of tiers for which at least one consumer of the first list qualifies.

6. The system of claim 5, wherein the processor is further configured to generate the second list to further contain indications of which tier at least one consumer of the second list qualifies.

7. The system of claim 6, wherein the second list is used to facilitate vehicle sales or loans and wherein the processor is further configured to cause a display of vehicles for sale to be limited based on at least one of the at least one consumer's tier indications, credit history record satisfying the one or more criteria, or the at least one vehicle's equity value.

8. The system of claim 1, wherein the processor is configured to identify which consumers of the first list have credit history records that satisfy the one or more criteria comprises configuring the processor to obtain credit history records for the at least one consumer on the first list and compare the obtained credit history record with the received one or more criteria.

9. An apparatus for determining a consumer prequalification and a vehicle equity, the apparatus comprising:
means for communicating via a communication network;
means for storing data;
means for providing an interface for operation at a remote computing device over the communication network;
means for receiving a first list of one or more consumers, the first list comprising at least a first name of and a last name of at least one consumer on the first list and at least one vehicle owned by the at least one consumer on the first list, the at least one vehicle on the first list identified by at least one of a vehicle identification number (VIN), a license plate number, or other unique identifier;
means for receiving one or more criteria for determining a prequalification status of the at least one consumer on the first list;
means for identifying which consumers of the first list have credit history records that satisfy the one or more criteria;
means for calculating vehicle equity values for the at least one vehicle on the first list based on the corresponding obtained vehicle history records and the credit history record of a corresponding owning consumer on the first list;
means for generating a second list of consumers based on comparison of credit history records and received one or more criteria and vehicles based on the calculated vehicle equity values; and
means for conveying the second list via the interface.

10. The apparatus of claim 9, wherein the one or more criteria is received via the interface and wherein the one or more criteria are selected based on lender or underwriter requirements, guideline, or scoring models.

11. The apparatus of claim 9, further comprising means for obtaining vehicle history records for the at least one vehicle on the first list corresponding to consumers identified as having credit history records satisfying the one or more criteria.

12. The apparatus of claim 9, wherein the means for generating the second list is configured to generate the second list to comprise only those consumers identified as having credit history records satisfying the one or more criteria and vehicles associated with those consumers.

13. The apparatus of claim 9, wherein the received one or more criteria comprises a plurality of tiers, wherein at least one tier of the plurality of tiers includes different criteria and wherein the means for identifying which consumers of the first list have credit history records that satisfy the selected one or more criteria is configured to identify which tier of the plurality of tiers for which the at least one consumer of the first list qualifies.

14. The apparatus of claim 13, wherein the means for generating the second list comprises indicating, in the second list, the tier for which at least one consumer of the second list qualifies.

15. The apparatus of claim 14, wherein the second list is used to facilitate vehicle sales or loans, the apparatus further comprising means for causing a display of vehicles for sale to be limited based on at least one of the at least one consumer's tier indications, credit history record satisfying the one or more criteria, or the at least one vehicle's equity value.

16. The apparatus of claim 9, wherein the means for identifying which consumers of the first list have credit history records that satisfy the one or more criteria comprises means for obtaining credit history records for the at least one consumer on the first list and means for comparing at least one obtained credit history record with the received one or more criteria.

17. A method for determining a consumer prequalification and a vehicle equity, the method comprising:
receiving, via an interface, a first list of one or more consumers, the first list comprising at least a first name of and a last name of at least one consumer on the list and at least one vehicle owned by the at least one consumer on the list, the at least one vehicle on the first list identified by at least one or more of a vehicle identification number (VIN), a license plate number, or other unique identifier;
receiving one or more criteria for determining a prequalification status of the at least one consumer on the first list;
identifying which consumers of the first list have credit history records that satisfy the one or more criteria;
calculating vehicle equity values for the at least one vehicle on the first list based on obtained vehicle history records and the credit history record of a corresponding owning consumer on the first list;
generating a second list of consumers based on comparison of credit history records and the received one or more criteria and vehicles based on the calculated vehicle equity values; and
conveying the second list via the interface.

18. The method of claim 15, wherein the one or more criteria is received via the interface and wherein the one or more criteria are selected based on lender or underwriter requirements, guideline, or scoring models.

19. The method of claim 15, further comprising obtaining vehicle history records for the at least one vehicle corresponding to consumers identified as having credit history records satisfying the one or more criteria.

20. The method of claim 15, wherein generating the second list comprises generating the second list to only comprise those consumers identified as having credit history records satisfying the one or more criteria and vehicles associated with those consumers.

21. The method of claim 15, wherein the received one or more criteria comprises a plurality of tiers, wherein at least one tier of the plurality of tiers includes different criteria and wherein identifying which consumers of the first list have credit history records that satisfy the selected one or more criteria comprises identifying which tier of the plurality of tiers for which the at least one consumer of the first list qualifies.

22. The method of claim 19, wherein generating the second list comprises indicating, in the second list, the tier for which at least one consumer of the second list qualifies.

23. The method of claim 20, wherein the second list is used to facilitate vehicle sales or loans, the method further comprising causing a display of vehicles for sale to be limited based on at least one of the at least one consumer's tier indications, credit history record satisfying the one or more criteria, or the at least one vehicle's equity value.

24. The method of claim 17, wherein identifying which consumers of the first list have credit history records that satisfy the one or more criteria comprises obtaining credit history records for the at least one consumer on the first list and comparing at least one obtained credit history record with the received one or more criteria.

25. A computer program product comprising a computer readable medium including instructions that, when executed, cause an apparatus to perform a method, the method comprising:
receiving, via an interface, a first list of one or more consumers, the first list comprising at least a first name of and a last name of at least one consumer on the list and at least one vehicle owned by the at least one consumer on the list, the at least one vehicle on the first list identified by at least one or more of a vehicle identification number (VIN), a license plate number, or other unique identifier;
receiving one or more criteria for determining a prequalification status of the at least one consumer on the first list;
identifying which consumers of the first list have credit history records that satisfy the one or more criteria;
calculating vehicle equity values for the at least one vehicle on the first list based on obtained vehicle history records and the credit history record of a corresponding owning consumer on the first list;
generating a second list of consumers based on comparison of credit history records and the received one or more criteria and vehicles based on the calculated vehicle equity values; and
conveying the second list via the interface.
